(19) United States
(12) Patent Application Publication
(10) Pub. No.: US 2010/0198773 A1
(43) Pub. Date: Aug. 5, 2010

(54) SYSTEM AND METHOD OF USING MOVIE TASTE FOR COMPATIBILITY MATCHING

(75) Inventor: Pascal Wallisch, New York, NY (US)

Correspondence Address: ROBERTS MLOTKOWSKI SAFRAN & COLE, P.C.;Intellectual Property Department, P.O. Box 10064, MCLEAN, VA, 22102-8064, US

(73) Assignee: PROMETHEAN VENTURES, LLC, Chicago, IL (US)

(21) Appl. No.: 12/513,651

(22) PCT Filed: Nov. 6, 2007
(86) PCT No.: PCT/US07/83712

§ 371 Date: Mar. 25, 2010

Related U.S. Application Data
(60) Provisional application No. 60/856,831, filed on Nov. 6, 2006.

(51) Int. Cl. G06N 5/02; H04W 4/12

(52) U.S. Cl. 706/54; 455/466

(57) ABSTRACT

A method of predicting the compatibility of at least one item of interest to a user of a web-based system. The method includes the steps of providing a survey of items for rating by the system user, collecting a set of ratings for the survey of items from the system user, collecting a set of ratings for the survey of items from each of a plurality of raters, calculating a correlation coefficient between the system user and each of the plurality of raters to obtain a set of correlation coefficients for the survey of items, selecting a group of raters from the plurality of raters, the group of raters selected on the basis that each member of the group of raters has provided a rating of the at least one item of interest and predicting the compatibility of the at least one item of interest to the system user from the ratings provided by the group of raters and the correlation coefficients calculated between the system user and each of the group of raters.

### CROSS REFERENCE TO RELATED CASES

The present invention claims priority under 35 U.S.C. §119(e) to U.S. Provisional Patent Application Ser. No. 60/856,831 of WALLISCH, entitled “SYSTEM AND METHOD OF USING MOVIE TASTE FOR COMPATIBILITY MATCHING,” filed on Nov. 6, 2006, the entire contents of which is incorporated by reference herein.

### FIELD OF THE INVENTION

The present invention relates generally to methods and systems for predicting user preferences. More specifically, the present invention is directed to the use of movie taste ratings in arriving at a compatible match.

### BACKGROUND OF THE INVENTION

People, when in the process of selecting an item, such as a movie to view, a book to read, music to listen to or any other item of content to experience, are often overwhelmed by the sheer volume of available selections. A critical question is how to benefit from the available information relating to such a selection, without getting bogged down by the overwhelming volume.

One possibility is to make use of the opinions that others have formed when experiencing an individual content item. Taken together, the collection of such opinions becomes a resource that could be used to sift through the available items. In the physical world, this technique is applied informally, through word-of-mouth and through forwarded mail, news, and web pages in the virtual world. However, these informal processes are not powerful enough to deal with the volume of new content being created.

To assist with this problem, recommendation services are available. A recommendation service can be a computer-implemented service that recommends items from a database of items. The recommendations are customized to particular users based on information known about the users. One common application for recommendation services involves recommending products to online customers. For example, online merchants commonly provide services for recommending products to customers based on profiles that have been developed for such customers. Recommendation services are also common for recommending websites, articles, and other types of informational content to users.

One technique commonly used by recommendation services is known as content-based filtering. Pure content-based systems operate by attempting to identify items which, based on an analysis of item content, are similar to items that are known to be of interest to the user. For example, a content-based website recommendation service may operate by parsing the user's favorite web pages to generate a profile of commonly-occurring terms, and then use this profile to search for other web pages that include some or all of these terms.

Another common recommendation technique is known as collaborative filtering. Collaborative filtering seeks to understand the relationships between people and to use those relationships to help people meet their needs more effectively. Ratings are entered by the user to indicate his or her opinion of the item of content to the collaborative filtering system. Based on previously entered ratings by other users, predictions are made for a user of the value of an item to that user. Ratings often represent the user's evaluation of the item of content along one or more dimensions. There are many possible dimensions, including overall enjoyment, value to the task at hand, interest in the topic, reputation of the author or producer, appropriateness for the context, quality of the material, etc. Ratings along each of these dimensions can be either explicit, requiring special user interaction, or implicit, captured from ordinary user actions.

The most common explicit rating methods in collaborative filtering systems are single keystrokes entered by users. The keystrokes usually represent values along a single ordered dimension. Ratings can also be entered through graphical sliders, which are similar, except that they often support more possible values. Another common rating method is textual ratings. Textual ratings are either keyword or free-form. Keyword textual ratings often focus on characterizing the topic. Keyword textual ratings that focus on measuring the quality are very similar to keystroke ratings. Free-form textual ratings can be valuable for users, but are difficult to process automatically. Free-form textual ratings are more common in domains in which the total number of documents is relatively low, so users can peruse a substantial fraction of them.

Implicit ratings may be collected by non-intrusively monitoring the user's use of the item of content. Observations about what the user does with the content may lead to insights into the value of the content to the user. For instance, if a user reads the title or abstract of a document, but chooses not to read the document, that may indicate low interest in the topic of the document. On the other hand, if the user chooses to save a document to a file, or to forward it to a colleague, that may indicate higher interest in the document. The time that a user spends reading a document is another implicit rating. Intuitively, users are likely to spend longer with documents they find valuable than with documents they find uninteresting.

Collaborative filtering systems have largely focused on explicit ratings. In small tightly focused groups with substantial shared interests, textual ratings have proven valuable. However, in larger groups with more diverse interests, a more structured ratings system with automatic computation of personalized predictions would be beneficial.

In a system using explicit ratings, the user responds to each item with a keystroke or other indication of preference. The system uses the user's response to influence its prediction algorithms for this user in the future. Users can informally combine their ratings along any of the possible ratings dimensions to create this single rating. Existing prediction algorithms do a good job of making predictions for users based on explicit ratings along this single dimension. However, there are many known prediction algorithms.

An area of scientific study which is focused on this problem is known as predictive utility. Predictive utility refers generally to the value of having predictions for an item before deciding whether to invest time or money in consuming that item. The concept is general enough to include physical items such as movies, books or videotapes, as well as information items, such as news articles or web pages. A domain with high predictive utility is one where users will adjust their decisions a great deal based on predictions. A domain with low predictive utility is one where predictions will have little effect on user decisions.

Predictive utility is a function of the relative quantity of desirable and undesirable items and the quality of predictions. The desirability of an item is a measure of a particular user's personal value for that item. Items are not intrinsically good or bad; an item is good for a user if that user finds it desirable and good in general if a large majority of users finds it desirable.

The cost-benefit analysis for a consumption decision compares the value of consuming a desirable item, a hit, the cost of missing a desirable item, a miss, the value of skipping over an undesirable item, a correct rejection, and the cost of consuming an undesirable item, a false positive. For watching a movie, the value of finding desirable movies is high to movie fans, but the cost of missing some good ones is low since there are many desirable movies for most movie fans. The cost of false positives is the price of the ticket plus the amount of time before the watcher decides to leave for each one, and the value of correct rejections is high because there are so many undesirable movies that without rejecting many of them it would be impractical to see movies at all. Restaurant selection can be seen to follow a similar pattern, though the risk of going to an undesirable restaurant is higher since you typically still have the meal and the bill. Legal research is very different. The cost of missing a relevant and important precedent is very high, and may outweigh the cost of sifting through all of the potentially relevant cases, especially when that cost is being billed to the client and serves as protection against malpractice.

The costs of misses and false positives represent the risk involved in making a prediction. The values of hits and correct rejection represent the potential benefit of making predictions. Predictive utility is the difference between the potential benefit and the risk. Thus, the risk of mistakes is lowest for movies and the potential benefit is highest for movies, articles and restaurants.

One important component of the cost-benefit analysis is the total number of desirable and undesirable items. If 90% of the items being considered are desirable, filtering will generally not add much value because there are few correct rejections and the probability of a hit is high even without a prediction. Of course, in some cases, users may refine their desires to select only the most interesting of the interesting ones given their limited time. On the other hand, if there are many items and only 1% are good, then filtering can add significant value because the aggregate value of correct rejections becomes high.

The issues involving compatibility matching may be extended beyond the items discussed to matching compatible people with one another. As may be appreciated, good matchmaking is the art of addressing an almost universal problem that has faced humans since ancient times; “How do I find the right life-partner for me?” This issue is of extreme importance, since failure results in some of the most significant sources of human suffering, namely remaining alone or, sometimes no less harmful, the fallout due to the choice of an essentially incompatible mate.

Given the fundamental structure of the mate choice challenge, such problems should not be surprising. The task of finding an appropriate mate seems almost intractable, even if one only focuses on solely psychological factors. It is conceptually and empirically well established that an enormously complex nervous system gives rise to a complex personality, capable of a wide range of sophisticated behaviors that are hard to predict. Given the intricacies of the nervous system, it comes as no surprise that there is ample room for an almost infinite number of variations, leading to a large variety of complex personalities.

At the same time, the opportunities for seeking a mate (“dating”) are typically limited to one's own surroundings. Depending on the physical setting and the activity of the individual, estimates for the pool of potential mates range from several hundred to several thousand potential partners. Depending on the variability of personality types and the importance of personality in successful mate choice, this sample is most likely too small to allow a good match. Even if one disregards mate-choice relevant factors like physical attractiveness or financial resources and abstracts from complexities like the competition of rivals, and if one grants potential “perfect” mates the cognitive ability to recognize each other, the endeavor is likely to fail due to the lack of a suitable mate in the pool of available potential mates, because of the relatively small size of said pool, compared to the varied and idiosyncratic nature of personalities.

A natural solution to this vexing problem is to cast a wider net in order to vastly expand the pool of potential mates. Online dating services are a logical solution to this problem, as they allow one to cast the net arbitrarily wide, far beyond the reach of conventional or accidental dating opportunities. A problem for these services is their current lack of ability to match users with people that are truly compatible. In principle, the idea is simple: The huge number of potential mates yielded by online dating services has to be narrowed down to a small number of matches using criteria that are both rather strict, eliminating many unsuitable mates, and relevant. The failure of conventional online dating services can be attributed to a number of simple yet crippling reasons.

One problem is that they use categories that are too broad. For example, there are dating services catering to specific ethnic or religious groups, like dating services that are aimed at Catholics, Jews or Indian Americans. Such a constraint is much too weak, leaving enough within category variance to render it ineffective. Moreover, the validity of such criteria depends on personal preferences, in other words if religion or race is a parameter in the mate choice search space of the user.

Another problem is that the questions used are not specific enough. For example, users are asked if they like movies or if they like to listen to music. Ultimately, this is both not constraining enough as well as of rather dubious validity.

Still another problem lies in the fact that many of the questions employed can't principally be answered introspectively. For example, users are typically asked how outgoing they are. It is highly unlikely that the user can answer this accurately by mere introspection. The basis of his or her answer would necessarily be self-perception while it is unclear how this relates to what the question really asks, namely how outgoing the individual is perceived by others. This problem is compounded by an enormous bias introduced by social desirability. Who would possibly admit that they are not outgoing when looking for a mate?

Typically, users are presented with a profile of potential mates. There is no compelling evidence that people are good at synthesizing the usually verbose information in a profile into the single relevant parameter: “How likely is it that this a good match?” As a matter of fact, people are notoriously bad at predicting what, and by proxy, who will make them happy.

From the foregoing it will be apparent that there is still a need for a method and system of predicting the compatibility of at least one item of interest to a person, which bases that prediction on the individual tastes of that person.

### SUMMARY OF THE INVENTION

In one aspect, provided is a method of predicting the compatibility of at least one item of interest to a user of a web-based system. The method includes the steps of providing a survey of items for rating by the system user, collecting a set of ratings for the survey of items from the system user, collecting a set of ratings for the survey of items from each of a plurality of raters, calculating a correlation coefficient between the system user and each of the plurality of raters to obtain a set of correlation coefficients for the survey of items, selecting a group of raters from the plurality of raters, the group of raters selected on the basis that each member of the group of raters has provided a rating of the at least one item of interest and predicting the compatibility of the at least one item of interest to the system user from the ratings provided by the group of raters and the correlation coefficients calculated between the system user and each of the group of raters.

In another aspect, provided is a method of predicting the compatibility of a first user of the system to at least one other user of the system. The method includes the steps of providing a survey of items for rating by the first system user, collecting a set of ratings for the survey of items from the first system user, collecting a set of ratings for the survey of items from each of a plurality of raters, calculating a correlation coefficient between the first system user and each of the plurality of raters to obtain a set of correlation coefficients for the survey of items, predicting the compatibility of the first system user to at least one of the plurality of raters from the correlation coefficients calculated between the system user and each of the group of raters and providing to the first system user at least one other user selected on the basis of correlation to the first system user from the plurality of raters.

In yet another aspect, provided is a multi-user web-based computer system for predicting the compatibility of at least one item of interest to a user of the system. The system includes a web server for communicating with users of the web-based computer system and components thereof, a user profile database for storing information on system users, a user rating module for providing a survey of items for rating by the system user and collecting a set of ratings for storage within the user profile database, a computational process module, the computational process module having a correlation module for calculating a correlation coefficient between the system user and each of a plurality of raters to obtain a set of correlation coefficients for the survey of items and a predictive module for predicting the compatibility of the at least one item of interest to the system user from the ratings provided by the plurality of raters and the correlation coefficients calculated between the system user and each of the plurality of raters, a compatibility-based matched items table for receiving an output regarding the compatibility of the at least one item of interest to the system user from the computational process module and a recommendation process module for receiving information from the compatibility-based matched items table and returning the information to the web server for transmitting to the system user.

In one form, the step of calculating a correlation coefficient between the system user and each of the plurality of raters to obtain a set of correlation coefficients for the survey of items includes the steps of obtaining a list of items from the survey of items that the system user and the plurality of raters have rated, storing the list of items in a temporary list in the form of rating pairs, calculating a mean user rating of survey items and a mean rater rating for each of the plurality of raters of survey items from the temporary list, calculating the difference between each user rating from the survey of items and the mean user rating, calculating the difference between each rater rating from the survey of items and the mean rater rating, multiplying the difference between each user rating and the mean user rating and the difference between each rater rating and the mean rater rating for each movie rate, summing the multiplied differences to determine a coefficient of variance, divided the sum so obtained by the number of items on the temporary list to arrive at a mean coefficient of variance, calculating a first standard deviation for the system user ratings on the temporary list and a second standard deviation of the rater ratings on the temporary list, calculating the product of the first and second standard deviations and dividing the mean coefficient of variance by the product of the first and second standard deviations to determine a correlation coefficient between a system user and a rater.

In another form, the step of predicting the compatibility of the at least one item of interest to the system user from the ratings provided by the group of raters and the correlation coefficients calculated between the system user and each of the group of raters includes the steps of selecting each system rater from the plurality of raters that has rated the item of interest, selecting and storing the correlation coefficients between the system user and the system raters selected, raising each correlation coefficient to the power of k to obtain a weight, calculating the sum of all weight, multiplying each weight by a corresponding rating and summing the product of each weight and corresponding rating to yield a raw score, dividing the raw score by the sum of all weights to obtain an estimate of prediction of compatibility of the at least one item of interest to the system user.

In yet another form, the step of predicting the compatibility of the at least one item of interest to the system user from the ratings provided by the group of raters and the correlation coefficients calculated between the system user and each of the group of raters further includes the steps of calculating an average item rating for the system user, calculating an average item rating for each system rater selected, calculating a correction factor by subtracting the second average item rating from the first average item rating determined and adding the correction factor to the estimate of rating prediction to obtain the prediction of compatibility of the at least one item of interest to the system user.

In still yet another form, a list of items of interest to the system user and their corresponding predictions of compatibility are provided over the mobile web to a web-enabled handheld device.

In further form, a list of items of interest to the system user and their corresponding predictions of compatibility are provided over the cellular telephone network to a cellular telephone via text message.

These and other features are described herein with specificity so as to make the present invention understandable to one of ordinary skill in the art.

### BRIEF DESCRIPTION OF THE DRAWINGS

The invention is further explained in the description that follows with reference to the drawings illustrating, by way of non-limiting examples, various embodiments of the invention wherein:

FIG. 1 is a schematic presenting the fundamental item rating scenario;

FIG. 2 presents a graphical depiction of a solution to the problem of compatibility matching involving a user, expert raters and items to be rated;

FIG. 3 presents a flowchart of a routine for calculating correlation coefficients for use in a correlation module;

FIG. 4 presents a flowchart of a routine for predicting user compatibility for use in a predictive module;

FIG. 5 presents a graphical depiction of a solution to the problem of compatibility matching among users;

FIG. 6 presents a graphical depiction showing a pooled rating vector of all people in the population for a given movie and a “wizard” that matches the pooled vector;

FIG. 7 illustrates a web-based computer system for predicting the compatibility of at least one item of interest to a user;

FIG. 8 presents a flowchart of a routine for providing item ratings over the mobile web; and

FIG. 9 presents a flowchart of a routine for providing item ratings over a cellular network via text message.

### DETAILED DESCRIPTION OF THE INVENTION

Disclosed herein is a system and method for using movie taste for comparability matching, each now described in specific terms sufficient to teach one of skill in the practice thereof. In the description that follows, numerous specific details are set forth by way of example for the purposes of explanation and in furtherance of teaching one of skill in the art to practice the invention. It will, however, be understood that the invention is not limited to the specific embodiments disclosed and discussed herein and that the invention can be practiced without such specific details and/or substitutes therefor. The present invention is limited only by the appended claims and may include various other embodiments which are not particularly described herein but which remain within the scope and spirit of the present invention.

In exploring the fundamental nature of movie ratings (“star ratings”), most studies conducted to date have been concerned with the impact of movie reviews by professional critics on the financial success of a movie or the coherence of the ratings of professional movie critics. Surprisingly, four questions have been virtually ignored: Are non-experts able to rate the quality of a movie in a consistent way—in other words, is there an inherent movie quality? Do professional experts or critics have better access to this inherent movie quality? What is the relationship between the judgment of critics and non-experts? Is movie taste among lay-people homogenous? The lack of relevant knowledge is even more surprising, as it is known that people use recommendations by critics to choose which movie to see, while it remains unknown how accurate these recommendations are.

As disclosed herein, it has been discovered that movies have an inherent quality that randomly picked people can agree upon. However, this agreement is very limited, reflected by an average correlation of about 0.26 between rating vectors of randomly picked individuals. Based on an understanding that is this low, vehement and decisive disagreement about the quality of a movie is to be expected frequently. Surprisingly, professional critics have, on average, no better access to this inherent quality than non-experts. This is true even for the most popular reviewers like Roger Ebert, whose correlation to the average non-expert is also about 0.26. Moreover, critics and non-experts seem to be out of phase. Non-experts are better at predicting non-experts, critics are better at predicting critics. On average, pooled non-expert judgments seem to give the best predictions to non-experts. The average correlation is on the order of 0.45 and close to the theoretically possible maximum, given the inherent variance of movie taste in the sample of non-experts. This theoretical maximum lies at around 0.49 and can not be surpassed by unweighted, averaged raters. This implies an enormous variance in the movie taste of individuals. Moreover, these results are extremely robust. Additionally, the 6 month retest-reliability of the survey is about 0.85, which is extremely high for this kind of data. The predictive utility of movie star ratings derives from the functional structure of the movie rating situation; that is, critics rate movies and people from the general public rate the same movies.

In one form, provided is a method of predicting the compatibility of at least one item of interest to a user of a web-based system. The method includes the steps of providing a survey of items for rating by the system user, collecting a set of ratings for the survey of items from the system user, collecting a set of ratings for the survey of items from each of a plurality of raters, calculating a correlation coefficient between the system user and each of the plurality of raters to obtain a set of correlation coefficients for the survey of items, selecting a group of raters from the plurality of raters, the group of raters selected on the basis that each member of the group of raters has provided a rating of the at least one item of interest and predicting the compatibility of the at least one item of interest to the system user from the ratings provided by the group of raters and the correlation coefficients calculated between the system user and each of the group of raters.

In another form, provided is a method of predicting the compatibility of a first user of the system to at least one other user of the system. The method includes the steps of providing a survey of items for rating by the first system user, collecting a set of ratings for the survey of items from the first system user, collecting a set of ratings for the survey of items from each of a plurality of raters, calculating a correlation coefficient between the first system user and each of the plurality of raters to obtain a set of correlation coefficients for the survey of items, predicting the compatibility of the first system user to at least one of the plurality of raters from the correlation coefficients calculated between the system user and each of the group of raters and providing to the first system user at least one other user selected on the basis of correlation to the first system user from the plurality of raters.

In yet another form, provided is a multi-user web-based computer system for predicting the compatibility of at least one item of interest to a user of the system. The system includes a web server for communicating with users of the web-based computer system and components thereof, a user profile database for storing information on system users, a user rating module for providing a survey of items for rating by the system user and collecting a set of ratings for storage within the user profile database, a computational process module, the computational process module having a correlation module for calculating a correlation coefficient between the system user and each of a plurality of raters to obtain a set of correlation coefficients for the survey of items and a predictive module for predicting the compatibility of the at least one item of interest to the system user from the ratings provided by the plurality of raters and the correlation coefficients calculated between the system user and each of the plurality of raters, a compatibility-based matched items table for receiving an output regarding the compatibility of the at least one item of interest to the system user from the computational process module and a recommendation process module for receiving information from the compatibility-based matched items table and returning the information to the web server for transmitting to the system user.

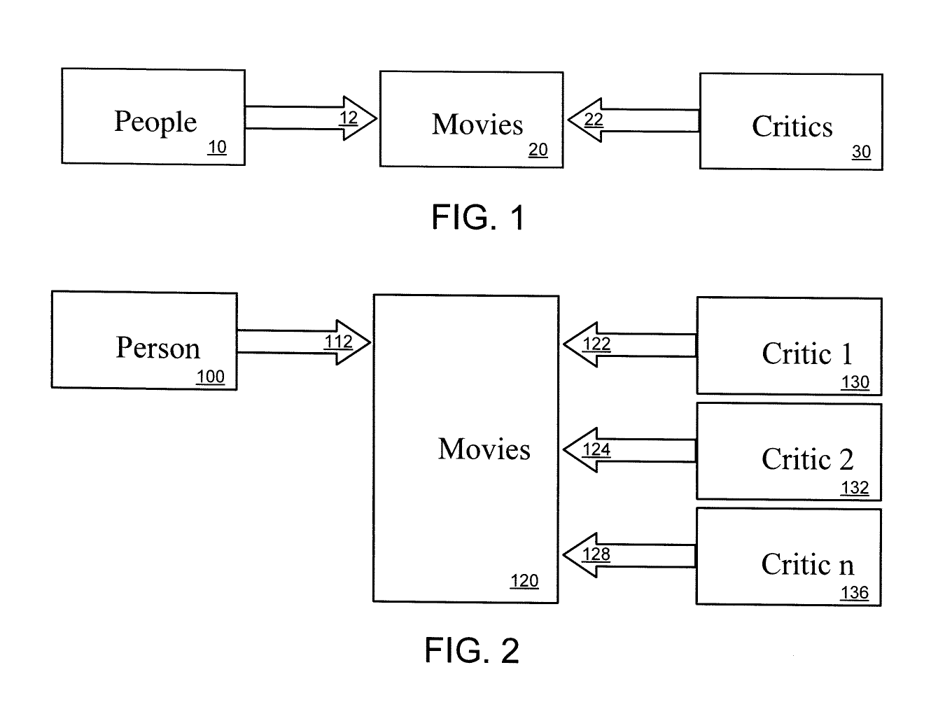

Referring now to FIG. 1, there are three entities critical to the process: people 10, critics 20 and movies 30 that can be related through the rating information contained in the star ratings. Both people and critics rate movies as a measure of how much they appreciate seeing them, which are indicated by arrows 12 and 22, respectively. It can be readily understood that FIG. 1 is somewhat simplified, in that these three categories consist of individual persons, movies and critics that collectively make up the population of people, movies and critics. Of course, people 10, movies 20 and critics 30 are related in more than these ways, since critics 30 also review movies 20 and people 10 buy movies 20, although the focus herein is on ratings and the way it connects these entities.

In one form, the present invention provides a method and system for matching critics to individual users. As may be appreciated, potential movie viewers face the problem of deciding which movie to select. This is by no means an easy problem, as the sheer number of movies prohibits a trivial solution, such as watching them all, and most publicly available information is a highly unreliable predictor of movie enjoyment (e.g. marketing campaigns, etc.)

Professional movie critics are one potential remedy to this problem. In theory, they can advise the movie-going public about what movies to see. Unfortunately, it can be shown that they are essentially just voicing their opinion and it is unlikely that this opinion is in tune with the taste of any given person. Moreover, it can be shown that people are generally poor at determining which critic reflects their tastes accurately when relying on intuitive judgment alone.

Referring now to FIG. 2, a schematic representation of this situation from the perspective of a given person 100 is shown. Person 100 has rated the movies 120. Individual critics 130, 132 and 136 have also rated the same movies. Arrow 112 represents a vector of judgments, in this case, the star ratings for movies the person 100 has seen, and hence the “movie taste” of the individual, as captured by these ratings. The particular taste vector 112 of person 100 can then be matched with the closest taste, that is, the most similar vector of judgments, from the group of critics. As shown in FIG. 2, this is schematically illustrated through the use of the gray level of the vectors and, in this example, vector 124 of the second critic 132 matches the taste of person 100 best, although, perhaps not perfectly.

Matching can be implemented in many different fashions. The most straightforward one is correlation. Correlation summarizes the strength of relationship between two variables. Several different correlation coefficients can be calculated, but the two most commonly used in the art are Pearson's correlation coefficient and Spearman's Rank Correlation coefficient. Pearson's correlation coefficient requires both variables to be measured on an interval or ratio scale and the calculation is based on the actual values. The Spearman Rank Correlation is a nonparametric, distribution-free, rank statistic proposed by Spearman in 1904 as a measure of the strength of the associations between two variables. Spearman's Rank Correlation coefficient requires data that are at least ordinal and the calculation, which is the same as for Pearson correlation, is carried out on the ranks of the data. Each variable is ranked separately by putting the values of the variable in order and numbering them: the lowest value is given rank 1, the next lowest is given rank 2 and so on. If two data values for the variable are the same they are given averaged ranks, so if they would have been ranked 14 and 15 then they both receive rank 14.5.

Spearman's Rank Correlation coefficient is used as a measure of linear relationship between two sets of ranked data, that is, it measures how tightly the ranked data cluster around a straight line. Spearman's Rank Correlation coefficient, like all other correlation coefficients, will take a value between −1 and +1. A positive correlation is one in which the ranks of both variables increase together. A negative correlation is one in which the ranks of one variable increase as the ranks of the other variable decrease. A correlation of +1 or −1 will arise if the relationship between the two variables is exactly linear. A correlation close to zero means there is no linear relationship between the ranks.

To use Pearson's correlation coefficient, it is necessary to assume that both variables have a normal distribution. No such assumption is necessary for tests using Spearman's rank correlation. Thus, Spearman's coefficient is preferred over Pearson's coefficient if either the data are ordinal or ranked or if it is unreasonable to assume that the variables are normally distributed.

In the practice of the method disclosed herein, the Spearman correlation is preferred, due to the fact that the data are on an ordinal scale and has been shown to yield sufficiently close matches. The Spearman rank correlation coefficient can be used to give an R-estimate, and is a measure of monotone association that is used when the distribution of the data make Pearson's correlation coefficient undesirable or misleading.

The Spearman rank correlation coefficient is defined by:

$${r}^{′} ≡ 1 - 6 \sum \frac{{d}^{2}}{N ( {N}^{2} - 1 )} ,$$

where d is the difference in statistical rank of corresponding variables, and is an approximation to the exact correlation coefficient

$$r ≡ \frac{Σ \times y}{\sqrt{Σ {\times }^{2} Σ {y}^{2}}}$$

computed from the original data. Because it uses ranks, the Spearman rank correlation coefficient is much easier to compute.

As appreciated by those skilled in the art, the procedure for using Spearman's Rank Correlation may be given as follows:
1. State the null hypothesis i.e. “There is no relationship between the two sets of data;”
2. Rank both sets of data from the highest to the lowest. Make sure to check for tied ranks;
3. Subtract the two sets of ranks to get the difference d;
4. Square the values of d;
5. Add the squared values of d to get Sigma d²;
6. Use the formula:

$${r}^{′} ≡ 1 - 6 \sum \frac{{d}^{2}}{N ( {N}^{2} - 1 )} ,$$

where N is the number of ranks;
7a. If the value is −1, there is a perfect negative correlation;
7b. If the value falls between −1 and −0.5, there is a strong negative correlation;
7c. If the value falls between −0.5 and 0, there is a weak negative correlation;
7d. If the value is 0, there is no correlation;
7e. If the value falls between 0 and 0.5, there is a weak positive correlation;
7f. If the value falls between 0.5 and 1, there is a strong positive correlation
7e. If the value is 1, there is a perfect positive correlation between the 2 sets of data; and
8. If the value is 0, state that null hypothesis is accepted. Otherwise, state that it is rejected.

Of course, as those skilled in the art will plainly recognize, it is possible to implement this matching with any number of other similarity measures, most of which should give results that are roughly equivalent. The closeness of the match and the amount of remaining variation to be expected can also be quantified. This is particularly important for individuals with rather idiosyncratic tastes.

In essence, the method disclosed herein provides the user with information about which movie critic judges movies in a fashion that reflects his or her own movie taste most closely. A sufficiently large database of movie critics will almost certainly yield a close match. This is important since once the user has found a reviewer that objectively matches his own movie taste, he or she can also access a large reservoir as well as a current stream of reviews, since many professional critics pride themselves in their timely reviews as well as their huge archives of existing movie reviews. This service might be interesting to most critics as well, since there is evidence that a few popular critics are not necessarily very accurate for the majority of people and they can monopolize the market for movie reviews.

In another form, the present invention provides a method and system for matching movies to individual users. As may be appreciated, there is a large choice of potential movies to view, yet only limited money and in time in which to see them all. Hence, the user faces a serious choice problem, as he or she has to optimize his enjoyment under uncertainty and a large choice set. Moreover, time is also a constraint, in that it is also required for reading movie reviews. Even if one finds a matching critic, as described hereinabove, reading and sifting through movie reviews can take a significant amount of time. More importantly, the best match to a critic might still not be as good as the limit given by the retest-reliability (above 0.85). Hence, the suggestions by the critic might not be the best possible. As such, the algorithm for movie recommendations disclosed herein is superior.

Referring again to FIG. 2, a user 100 rates movies 120, as do critics 130, 132, 136, etc. As may be appreciated, one could take all of the ratings of the critics, average them for each movie and arrive at a predictor vector of all of the combined critics. This methodology is available and provided at websites such as rottentomatoes.com and metacritic.com. One can imagine that the grey-scale color of the combined rating vector would be somewhere in the middle of the spectrum, as one takes all the different flavors of the critics' tastes, equally, into account. Unfortunately, this vector can be shown to empirically match the vector of the individual user 100 with a correlation of only 0.42. This is due to the fact that critics are systematically biased and individual movie taste is very different. Hence, the equal weights solution is very suboptimal. On the other hand, a pooled vector is theoretically optimal, given that it is weighted by the preferences of the user 100. In other words, if the vector 122 of an individual critic 130 closely matches the vector 112 of the user 100, it will be assigned a greater weight in determining the luminance, or grey level, of the final vector than those of a critic that does not match the vector 122 of the user 100. This two-step process of weighted pooling can then be extended to predict star ratings of movies that the user 100 has not already seen. Predicting the star rating of movies 120 that the user has already seen gives a sense of how accurate the predictions are, on average, as one can compare the predicted pooled, weighted vector from the critics with the actual vector 112 of the user 100.

There are several ways to implement this. One formula is:

$${s}^{*} = \frac{\sum ( {r}_{i}^{k} {s}_{j} )}{\sum {r}_{i}^{k}}$$

where s* is the predicted movie rating for a given movie, rᵢ is the correlation between the star rating of a given user and a particular critic (for all movies except the one under prediction), sⱼ is the star rating from a particular critic for the given movie under prediction and k is a scaling factor that is to be optimized empirically.

Alternatively, the weighted pooled vector from all non-critic persons can be used, but this might be sub-optimal as the number of movies seen is typically larger for critics, hence r can be expected to be more robust. However, as the optimum is arrived at quickly, as i becomes relatively large, this factor is minimized. Also, the introduction of bounding factors to bound the result to values between 0 and 4 or 0 and 100 or −10 and 10 may be desirable.

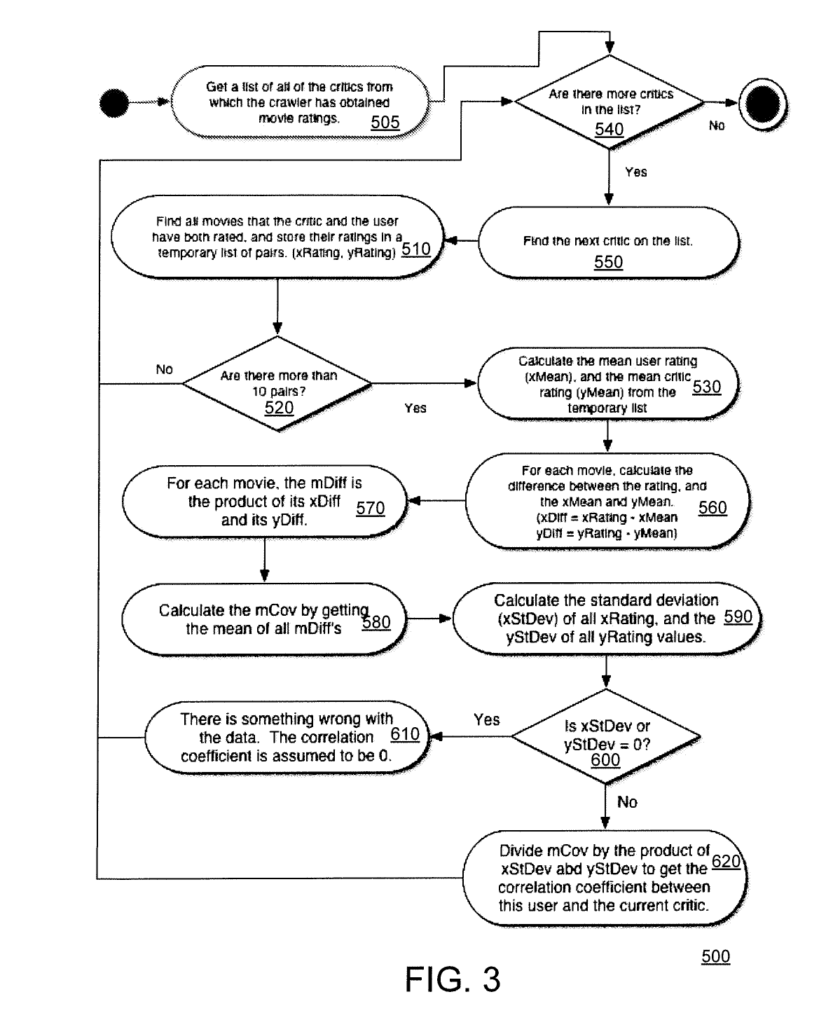

Referring now to FIG. 3, a correlation module 500 for use in a system for correlating a given user with a given rater or reviewer (critic) is depicted. As shown, correlation module 500 executes the following steps:

In step 510, all movies that both the reviewer and the user have rated are found and the ratings of these movies stored in a temporary list of rating pairs. At step 520, a check is made to determine if the list has more than 10 pairs; if so, continue to step 530; if not, continue to step 540 to determine if there is another critic. As shown, information is supplied from step 505, which provides a list of all critics from which movie ratings have been obtained. If so, another critic is entered into the system at step 550; if not, the process must terminate, since the correlation will have little value for a small number of pairs.

At step 530, a mean user rating of movies for the temporary list (xmean) and a mean critic rating of movies for the temporary list (ymean) are calculated. At step 560, for each movie rating, the differences between the rating and the respective means are calculated and stored as xdiff and ydiff. As may be appreciated, there will be as many values for xdiff and ydiff as there are movies on the temporary list. At step 570, the differences for each movie are multiplied (xdiff1×ydiff1; xdiff2×ydiff2, etc.) and stored as mdiff1, mdiff2, etc.

At step 580, the multiplied differences are summed to arrive at the coefficient of variance (cov=mdiff1, mdiff2, etc.) and the sum (cov) is divided by the number of movies on the temporary list to arrive at mcov. At step 590, the standard deviation of the user ratings on the list (stdevx) and the standard deviation of the critic ratings on the list (stdevy) are calculated.

At step 600, a check is made to determine if either stdevx or stdevy is equal to 0. If yes, the process is aborted and the correlation coefficient assumed to be 0 at step 610. Of course, to expedite calculations, this could be executed as step 530, but is presented as step 600 due to the logic of correlation. If no, the product of the two standard deviations is calculated and stored as pdev (pdev=stdevx×stdevy) and mcov is divided by pdev to arrive at the correlation. As may be appreciated, this yields the Pearson Product-Moment Correlation coefficient (corr) between a given user and a given rater, reviewer (critic), for a given list of commonly seen movies.

As may be appreciated, the estimate may need to be bounded. For example, as mentioned above, if the sum of the weights is close to 0, the final prediction would be close to the minimal or maximal value assigned by predictive module 700 (0 to 4 or 0 to 10), depending on the sign of denominator and numerator. Similar problems may arise if the summed numerator is less than 1. In this case, all weights may be assigned the value of 1 to determine the prediction, although this case will be rare.

This strategy exploits the correlational structure inherent in the movie taste of critics and non-critic persons and can be shown to be superior to any individual recommendation source (be it critic or other individual), for any given user, since it takes large amounts of information into account in an optimal fashion. This method yields extremely accurate results and is believed to be very similar to the algorithm the brain of rhesus monkeys employs to arrive at perceptual decisions about moving objects. In effect, this presents the user with the best possible speed/accuracy tradeoff. He or she has to spend no time reading reviews, yet the accuracy of the recommendations increases up to the theoretically possible maximum.

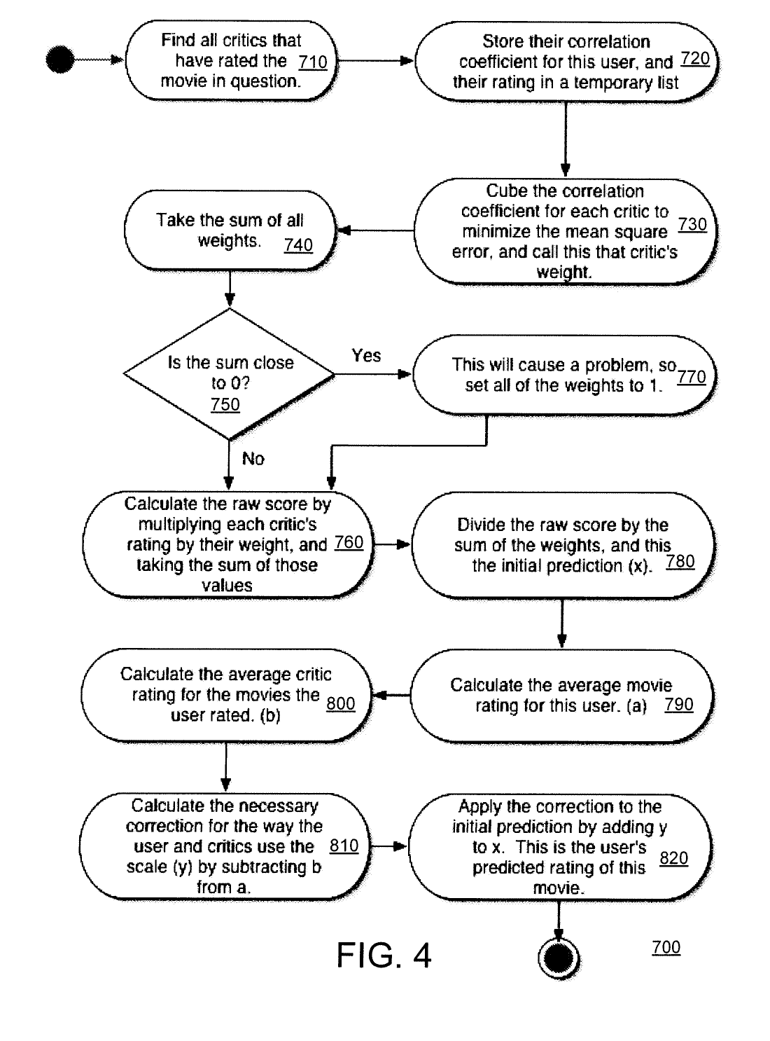

Referring now to FIG. 4, in order to predict the compatibility of at least one item of interest, for example, but not by way of limitation, a movie or book or the like, to a user, a predictive module 700 executes the following steps.

At step 710, select all system raters, which may be experts, movie critics, other system users, or the like, who have given this item a rating, (rating1, rating2, etc.) At step 720, select and store the correlation coefficients between the user and the each of the system users who have given this item a rating (corr1, corr2, etc.). At step 730, each correlation coefficient is raised to the power of k, where k is an empirically derived number that minimizes the mean squared error, for example, but not by way of limitation, k may be 3. (weight1, weight2, etc.).

At step 740, the sum of all weights is taken. At step 750, a check is made to determine if the sum of all weights is close to 0; if so, then all weights are set to 1 at step 770. If the sum of all weights is not close to 0, then, each weight is multiplied by its corresponding rating at step 760, and then those products are summed. This yields a raw score.

At step 780, the raw score of step 760 is divided by the sum of the weights, derived above. The result of this computation is the estimate of the rating prediction x. At step 790, the average item rating is calculated for the system user (a) in order to account for different scale use by different raters and to assure that the absolute ratings are meaningful. At step 800, the average item rating is calculated for the system raters (b). At step 810, a correction factor (y) is calculated to account for the difference in scale use between the system user and the system raters. The correction factor y is determined by subtracting b from a. At step 820, the correction factor y is applied to the initial prediction x, determined in step 780, to obtain a final a rating prediction. The final rating prediction is obtained by adding y to the initial prediction x.

As movie distribution moves online, it introduces a very long “tail”. The “long tail” is a phenomenon that has been, so far, chiefly observed in the online sale of book and music. For example, Amazon has an inventory of several million titles, most of them rather obscure, generally not available in offline book stores and with rather low individual sales volume. However, it has been shown that Amazon generates the majority of its sales revenue outside of the top 130,000 sellers. As may be appreciated, movie taste is rather idiosyncratic. A “good” movie is simply a movie that many people enjoy watching, not necessarily something that is inherent to the movie or relative to other movies. Shifting the focus on the enjoyment of the individual makes it irrelevant, from the perspective of the individual, how many other people enjoy watching a given movie. Hence, it will be of chief importance to match the right flavor of idiosyncratic taste with the right flavor of idiosyncratic movie. There is a total of about 850,000 movies in existence, although even the better offline rental stores typically carry only a mere several thousand titles. As such, the “long tail” problem is likely to become an increasingly important issue in movie selection as online distribution on demand becomes more prevalent.

In another form, the present invention provides a method and system for matching people to one another. The present invention addresses the issue that current online dating services, while providing a much larger sample of potential mates, are plagued by the use of constraints that are both too non-restrictive and often invalid, leading to a failure to actually elicit a good match.

In many ways, the current dating situation mirrors the search engine market before the advent of Google. In 1997, Altavista had cataloged the entire internet in a huge index and was able to provide a response to any query within fractions of a second. Yet, users were dissatisfied since the results of their search queries rarely matched what they were looking for. The success of Google is largely based on the fact that Google provides a way to rank-order pages in terms of relevance. The present invention achieves similar benefits by automatically rank-ordering potential matches in a way that is meaningful to the user.

Data obtained on couples, failed couples and people that have not been in a relationship, can be correlated with movie ratings. As pointed out above, the correlation between two randomly picked participants in the study is 0.26, on average. The correlation between couples is significantly higher, about twice that. Conversely, the correlation between failed couples is marginally, yet insignificantly lower than the correlation between randomly picked people.

There are several factors that determine the rating that a given individual assigns to a given movie. First of all, the objective movie quality. Second, emotional, social and environmental factors present both during encoding (watching the movie) and retrieval (assigning the rating) of the movie information. Third, random noise and uncertainty in assigning a number to a movie. These factors, taken together, are rather insignificant as the re-test reliability is above 0.85. Finally, if these factors are constant or insignificant, personality necessarily has to be the key factor accounting for the tremendous variance observed for every single movie in the study. Ultimately, it needs to be explained why the correlation between two randomly picked individuals is as low as it is and why the spread of ratings for any given movies is so large.

This large variance is a nuisance when trying to make accurate movie recommendations. On the other hand, turning the problem on its head, this variance becomes an immediate treasure trove when trying to estimate personality based on movie ratings. Due to the inherent variance in these ratings, the inverse problem seems to be much easier and rich in information. Of course, this strongly depends on the question if this variance in ratings for a given movie is systematic or not. The observed pattern of correlations between couples, failed couples and randomly picked people that don't date suggests exactly that; that the pattern is highly systematic.

Movie ratings may be employed to rank potential mates, for example, in online dating. It has been shown that high similarity in personality parameters is the basis for a good relationship. Hence, a higher correlation implies a higher chance of a good match. This approach seems feasible for a number of reasons. First, users seem to be perfectly able to effortlessly make these movie ratings and there is evidence that a good number of them enjoy doing so. Second, the “questions” (individual movies) are very specific and to the point. Third, social desirability will be unclear in most cases, based on the premise that a higher correlation is better and that the movie taste space is highly dimensional in itself, users would be well advised to be as honest as possible, since there is no single “solution” to each movie question, if they want to find an actual match. Finally and most importantly, movie taste seems to tap personality in a unique way. Hence, the same survey that was previously used to predict best individual critics and movies can be successfully employed for the online dating situation.

What ultimately determines which movies someone likes or hates? It may come down to someone's outlook on life, their philosophy, their humor, likes and dislikes, political positions, intelligence, all of which are prone to produce emotional reactions when confronted with and triggered by movies, creating the stable and distinctive ratings observed. In other words, movie ratings implicitly contain information about the so-called “inner values” that are so notoriously hard to probe, yet so important for a happy relationship.

Referring now to FIG. 3, the implementation of this procedure is depicted. Arrows 212, 214, 216 and 218 represent the rating vectors and the different shades of grey represent particular movie tastes. As shown, person 200 and person 204 have a closely matched movie taste. Hence, we would recommend them as a “match”, out of the many possible persons 200, 202, 204, 206 through person n. As described hereinabove, this can be implemented in many ways, with the Spearman Rank Correlation between the rating vectors being the most straightforward. As such, movie ratings provide the opportunity to rank potential mates based on their suitability as a mate, solving the problems of conventional dating sites due to the fact that they provide a relevant dimension of potentially arbitrary restrictiveness.

The approach disclosed herein also helps with social networking and movie recommendations, not necessarily just dating. As pointed out hereinabove, the average retest reliability of movie rating is about 0.85. It is relatively easy to find “statistical twins” in a large enough sample of persons via their movie rating vectors and match them up with each other. They can then keep each other informed about the quality of recent releases. Theoretically, the judgment of a person's “statistical twin” should be as good as if the person saw the movie him or herself.

In another form, the present invention provides a method and system for person to pooled person matching that can be tailored to assist in producing better movies. The present invention can be employed to ensure that the industry delivers a product that people will want to see. Current practice dictates that after the initial script-selection and green lighting process performed by producers and others, the movie is handed over to professional artists that make the movie. Then, standard industry practice calls for test-screenings after a movie is shot and edited to make it more palatable to the target audience. These test-screening are typically attended by a large and diverse crowd of whatever demographic the studio aims for reaching with the movie. The problem with this approach is that, while it is trivial to match the test audience in terms of the desired demographic parameters, it remains essentially unclear how well the test audience represents the population at large in terms of movie taste.

Referring now to FIG. 4, in accordance herewith, the screening of large numbers of people for their movie taste should allow the industry to identify individuals (“wizards”) that correlate with pooled population measures like the averaged ratings of all other participants combined essentially perfectly (>0.9). As shown, on the left, the pooled rating vector 370 of all people 350 in the population for a given movie 320. On the right is the rating vector 360 of a “wizard” person 340 that matches the pooled vector 370, compared to the vector 312 of a randomly picked non-wizard person 312.

These taste experts (“wizards”) 340 could consult movie-makers at every stage of the production process, ultimately delivering a better and more enjoyable product. This could cut down on expenses for advertising, since a strong product can rely more on word of mouth, test screenings, a few “expert” consultants would do, as well as increase the chances of delivering a movie that audiences actually like to see, want to see and will go to see, at which point the interests of movie goers who want to see an enjoyable movie and studios, wanting to make a bankable movie, converge.

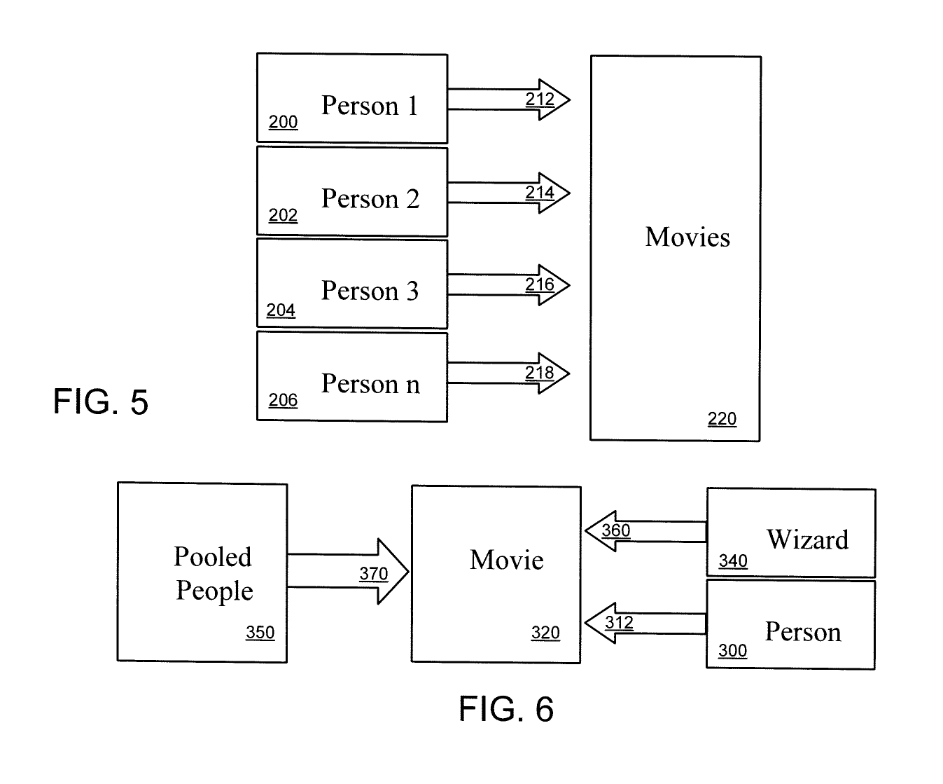

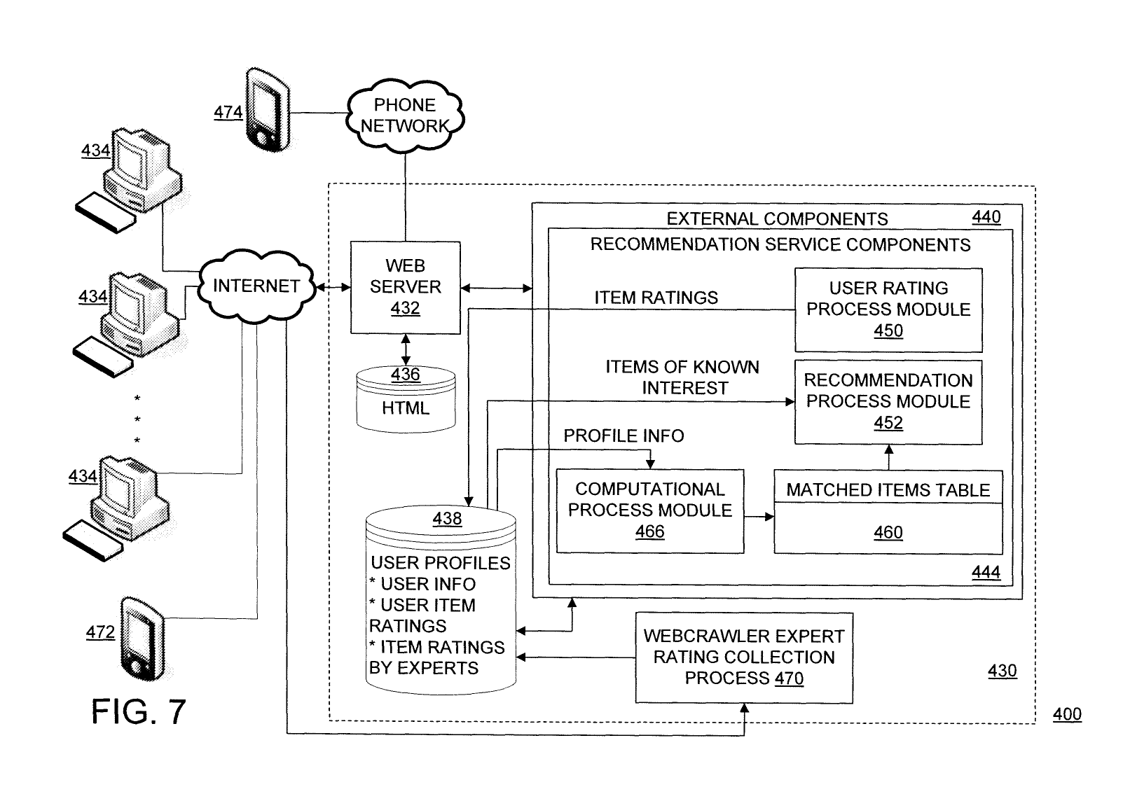

FIG. 5 illustrates the basic components of a compatibility matching web-based computer system 430, including the components used to implement the compatibility matching or recommendation service. The arrows in FIG. 5 show the general flow of information that is used by the recommendation service. As illustrated by FIG. 5, the web-based computer system 430 includes a web server application 432 (“web server”) which processes HTTP (Hypertext Transfer Protocol) requests received over the Internet from user computers 434. The web server 432 accesses a database 436 of HTML (Hypertext Markup Language) content which includes movie or other item information pages and other browsable information about the various items. The “items” that are the subject of the recommendation service are the titles of movies or other items of content employed that are found within this database 436.

The web-based computer system 430 also includes a “user profiles” database 438 which stores user-specific information about users of the web site. As illustrated by FIG. 5, the data stored for each user may include one or more of the following types of information, among other things, that can be used to generate matches or recommendations in accordance with the invention: (a) the user's past movie viewing history, (b) the user's item ratings profile, and (c) other user-specific information.

As depicted by FIG. 5, the web server 432 communicates with various external components 440 of the web-based computer system 430. These external components 440 include, for example, a search engine and associated database (not shown) for enabling users to interactively search for information on particular items. Other external components 440 may include various order processing modules (not shown) for accepting and processing orders, and for updating the purchase histories of the users.

The external components 440 may also include an optional shopping cart process (not shown) which adds and removes items from the users' personal shopping carts based on the actions of the respective users. As used herein, the term “process” is used to refer generally to one or more code modules that are executed by a computer system to perform a particular task or set of related tasks. The shopping cart process may also generate and maintains the user-specific listings of recent shopping cart contents.

The external components 440 also include compatibility matching recommendation service components 444 that are used to implement the web-based computer system's various recommendation services. Recommendations generated by the compatibility matching recommendation services are returned to the web server 432, which incorporates the recommendations into personalized web pages transmitted to users containing the matched items.

The recommendation service components 444 include a user rating application process 450 which implements a user rating service for a plurality of items. Users of the user rating service are provided the opportunity to rate individual movies or other items from a pre-selected list. The movie titles or other items are rated according to a four-star scale, in half-star increments, wherein zero is bad and four is excellent.

As depicted in FIG. 5, the user rating application 450 records the ratings within the user's items rating profile. For example, if a user of the user rating service gives the movie Gone with the Wind a score of “4 stars,” the user rating application 450 would record the item, by title (or identifier), and the score within the user's item ratings profile. The user rating application 450 uses the users' item ratings to generate taste vectors, as described herein-above for use in ultimately generating personal recommendations, which can be requested by the user by selecting an appropriate hyperlink.

The compatibility matching recommendation services components 444 also include a recommendation process 452, a compatibility-based matched items table 460, and a computational process 466, which collectively implement the compatibility matching recommendation service. The computational process 466 includes correlation module 500 (see FIG. 3) and predictive module 700 (see FIG. 4), each of which described in detail hereinabove. As depicted by the arrows in FIG. 5, the recommendation process 452 generates personal recommendations based on information stored within the compatibility-based matched items table 460, and based on the items that are known to be of interest. The items of known interest are identified based on information stored in the user's profile.

A webcrawler expert rating collection process 470 may be provided, which searches the web for movie or other item ratings information for use in generating expert taste vectors, as described in detail hereinabove. The output of the webcrawler expert rating collection process 470 is fed to computational process 466 for use in the compatibility matching recommendation process 452.

The various processes 450, 452, 466 and 470 of the recommendation services may run, for example, on one or more Unix or Windows-based workstations or physical servers (not shown) of the web-based computer system 430. The compatibility-based matched items table 460 may be stored in a data structure that permits efficient look-up, and may be replicated across multiple machines, together with the associated code of the recommendation process 452, to accommodate heavy loads.

The general form and content of the matched items table 460 will now be described with reference to FIG. 5. As this table can take on many alternative forms, the details of the table are intended to illustrate, and not limit, the scope of the invention.

As indicated above, the compatibility-based matched items table 460 maps items to lists of similar items based at least upon the taste vector of another user or expert or the weighted vectors of several users or experts, as described herein above, that has been matched to a particular user selected from the community of users. The compatibility-based matched items table 460 is preferably generated periodically (e.g., once per day) by the computational process 466. In the form described herein, the matched items table 460 is, therefore, generated exclusively from the user ratings of the community of users and/or experts. In other embodiments, the compatibility-based table 460 may additionally be generated from other indicia of user-item interests, including indicia based on shopping cart activities, and rating profiles for other item categories (books, for example).

In other forms involving sales of products, the compatibility-based table 460 may include entries for compatibility-matched, recommended products of the online merchant. In this form, several different types of items (movies, books, CDs, etc.) may be included within the same compatibility-based table 460, although separate tables could alternatively be generated for each type of item. Each matched items table 464 consists of at least one list containing N (e.g., 5) items which are predicted to be the most compatible with the user's taste.

The items are represented within the matched items table 460 using movie titles or relevant product IDs, or other identifiers. Although the recommendable items in the described system are in the form of movie titles, book titles or music titles, it will be appreciated that the underlying methods and data structures can be used to recommend a wide range of other types of items, including compatible persons for dating, as has been described hereinabove.

It is also contemplated that information from system 400 can be made available over the mobile web to a plurality of handheld devices 472 or over the cellular telephone network to a plurality of cellular telephones 474 via text message.

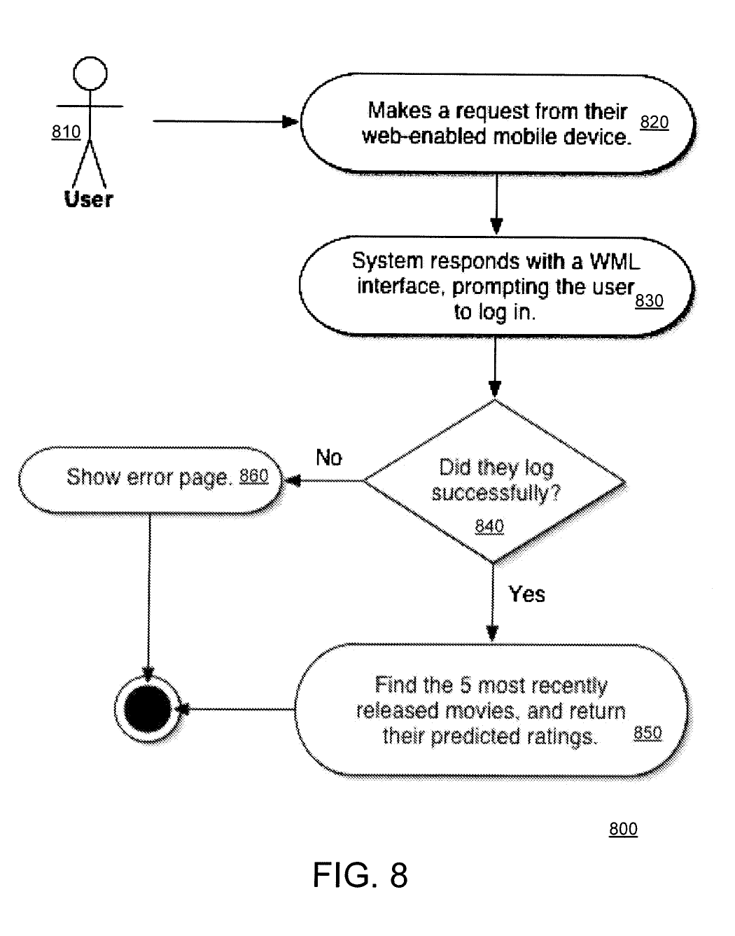

Referring now to FIG. 8, a process for providing movie ratings or other items of interest 800 to a system user 810 over the mobile web is depicted. As shown, at step 820, user 810 makes a request via a web-enabled mobile device. System 400 (see FIG. 5), responds with a Website Meta Language (WML) interface, prompting the user to log into the system 400. At step 840, a check is made to determine if user 810 logged in successfully. If so, system 400 responds by sending to device 472 a list, for example, but not by way of limitation, of the most recently released movies and their predicted ratings, the predictions determined as described hereinabove. If the user 810 has not logged in successfully, an error page is transmitted at step 860 to device 472.

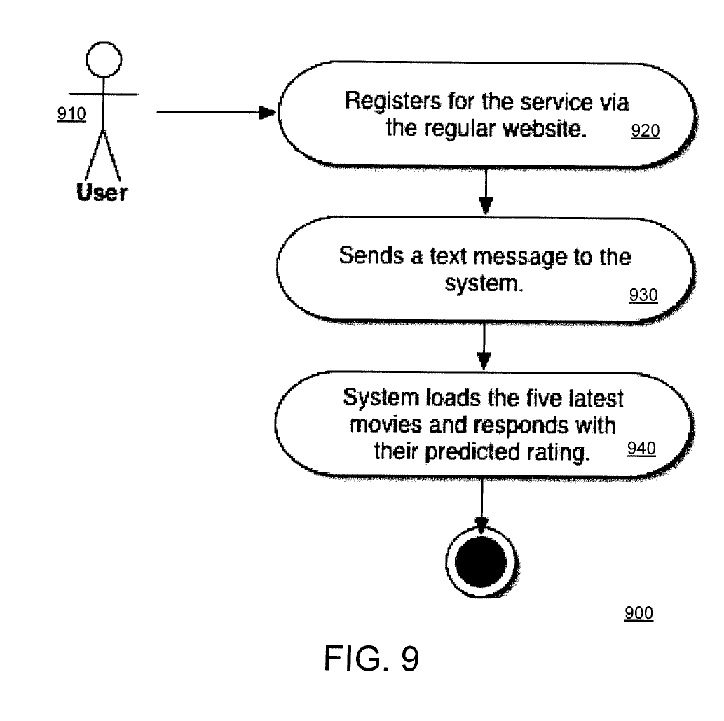

Referring now to FIG. 9, a process for providing movie ratings or other items of interest 900 to a system user 910 over a cellular telephone network, via text message, is depicted. As shown, at step 920, user 910 registers for the service via a cellular telephone device 474 and sends a text message at step 930 to system 400 (see FIG. 5). System 400 responds, for example, but not by way of limitation, with a list of most recently released movies and their predicted ratings, the predictions determined as described hereinabove.

As has been shown, adequately gathered movie ratings provide a rich source of information for a diverse range of potential uses.

### Example

A survey was designed consisting of 210 movies, picked largely at random, while ensuring movie popularity. Data were collected from about 2000 subjects. The data were generated by having subjects rate how much they enjoyed a given movie from the list on a 9-point scale, that is, from 0 to 4 “stars,” in increments of half-stars.

These data revealed that movies have an inherent quality that randomly picked people can agree upon. However, this agreement has been found to be very limited, reflecting by an average correlation of about 0.26.

Professional critics were found to, on average, no better access to this inherent quality than non-experts. This is true even for the most popular reviewers like Roger Ebert, whose correlation to the average non-expert was found to be 0.26.

On average, pooled non-expert judgments seem to give the best predictions to non-experts. The average correlation was found to be on the order of 0.45 and close to the theoretically possible maximum, given the inherent variance of movie taste in the sample of non-experts. This theoretical maximum lies at around 0.49 and can not be surpassed by unweighted, averaged raters. This implies an enormous variance in the movie taste of individuals.

Using a weighted average-based algorithm to create a most likely rating for a given movie by weighing the ratings from others by their overall correlation to the subject user, minus the given movie, achieving an average correlation of 0.72, substantially better than the 0.49 barrier for untailored recommendations.

All patents, test procedures, and other documents cited herein, including priority documents, are fully incorporated by reference to the extent such disclosure is not inconsistent with this invention and for all jurisdictions in which such incorporation is permitted.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the invention, including all features which would be treated as equivalents thereof by those skilled in the art to which the invention pertains.

What is claimed is:

1. A method of predicting the compatibility of at least one item of interest to a user of a web-based system, comprising the steps of:
(a) providing a survey of items for rating by the system user;
(b) collecting a set of ratings for the survey of items from the system user;
(c) collecting a set of ratings for the survey of items from each of a plurality of raters;
(d) calculating a correlation coefficient between the system user and each of the plurality of raters to obtain a set of correlation coefficients for the survey of items;
(e) selecting a group of raters from the plurality of raters, the group of raters selected on the basis that each member of the group of raters has provided a rating of the at least one item of interest; and
(f) predicting the compatibility of the at least one item of interest to the system user from the ratings provided by the group of raters and the correlation coefficients calculated between the system user and each of the group of raters.

2. The method of claim 1, wherein the survey of items is a list of movies.

3. The method of claim 2, wherein the plurality of raters are selected from a list of system users.

4. The method of claim 2, wherein the plurality of raters are selected from a group of movie critics who have each rated the list of movies.

5. The method of claim 4, wherein the set of ratings for the survey of items is obtained using at least one web crawler.

6. The method of claim 1, wherein said step of calculating a correlation coefficient between the system user and each of the plurality of raters to obtain a set of correlation coefficients for the survey of items comprises the steps of:
(i) obtaining a list of items from the survey of items that the system user and the plurality of raters have rated;
(ii) storing the list of items obtained in step (i) in a temporary list in the form of rating pairs;
(iii) calculating a mean user rating of survey items and a mean rater rating for each of the plurality of raters of survey items from the temporary list;
(iv) calculating the difference between each user rating from the survey of items and the mean user rating; and
(v) calculating the difference between each rater rating from the survey of items and the mean rater rating.

7. The method of claim 6, wherein said step of calculating a correlation coefficient between the system user and each of the plurality of raters to obtain a set of correlation coefficients for the survey of items further comprises the steps of:
(vii) multiplying the difference between each user rating and the mean user rating and the difference between each rater rating and the mean rater rating for each movie rate;
(viii) summing the multiplied differences from step (vii) to determine a coefficient of variance;
(ix) dividing the sum obtained in step (viii) by the number of items on the temporary list to arrive at a mean coefficient of variance;
(x) calculating a first standard deviation for the system user ratings on the temporary list and a second standard deviation of the rater ratings on the temporary list;
(xi) calculating the product of the first and second standard deviations; and
(xii) dividing the mean coefficient of variance obtained in step (ix) by the product of the first and second standard deviations obtained in step (xi) to determine a correlation coefficient between a system user and a rater.

8. The method of claim 7, wherein said step of predicting the compatibility of the at least one item of interest to the system user from the ratings provided by the group of raters and the correlation coefficients calculated between the system user and each of the group of raters comprises the steps of:
(i) selecting each system rater from the plurality of raters that has rated the item of interest;
(ii) selecting and storing the correlation coefficients determined in step (d) between the system user and the system raters selected in step (i);
(iii) raising each correlation coefficient to the power of k to obtain a weight;
(iv) calculating the sum of all weights;
(v) multiplying each weight by a corresponding rating and summing the product of each weight and corresponding rating to yield a raw score; and
(vi) dividing the raw score of step (v) by the sum of all weights determined in step (iv) to obtain an estimate of prediction of compatibility of the at least one item of interest to the system user.

9. The method of claim 8, wherein said step of predicting the compatibility of the at least one item of interest to the system user from the ratings provided by the group of raters and the correlation coefficients calculated between the system user and each of the group of raters further comprises the steps of:
(vii) calculating an average item rating for the system user;
(viii) calculating an average item rating for each system rater selected in step (i);
(ix) calculating a correction factor by subtracting the average item rating determined in step (viii) from the average item rating determined in step (vii); and
(x) adding the correction factor determined in step (ix) to the estimate of rating prediction determined in step (vi) to obtain the prediction of compatibility of the at least one item of interest to the system user.

10. The method of claim 1, wherein said step of predicting the compatibility of the at least one item of interest to the system user from the ratings provided by the group of raters and the correlation coefficients calculated between the system user and each of the group of raters comprises the steps of:
(i) selecting each system rater from the plurality of raters that has rated the item of interest;
(ii) selecting and storing the correlation coefficients determined in step (d) between the system user and the system raters selected in step (i);
(iii) raising each correlation coefficient to the power of k to obtain a weight;
(iv) calculating the sum of all weights;
(v) multiplying each weight by a corresponding rating and summing the product of each weight and corresponding rating to yield a raw score; and
(vi) dividing the raw score of step (v) by the sum of all weights determined in step (iv) to obtain an estimate of prediction of compatibility of the at least one item of interest to the system user.

11. The method of claim 10, wherein said step of predicting the compatibility of the at least one item of interest to the system user from the ratings provided by the group of raters and the correlation coefficients calculated between the system user and each of the group of raters further comprises the steps of:
(vii) calculating an average item rating for the system user;
(viii) calculating an average item rating for each system rater selected in step (i);
(ix) calculating a correction factor by subtracting the average item rating determined in step (viii) from the average item rating determined in step (vii); and
(x) adding the correction factor determined in step (ix) to the estimate of rating prediction determined in step (vi) to obtain the prediction of compatibility of the at least one item of interest to the system user.

12. The method of claim 1, further comprising the step of:
(g) providing a list of items of interest to the system user and their corresponding predictions of compatibility over the mobile web to a web-enabled handheld device.

13. The method of claim 12, wherein the list of items of interest is a list of most recently released movies.

14. The method of claim 1, further comprising the step of:
(g) providing a list of items of interest to the system user and their corresponding predictions of compatibility over the cellular telephone network to a cellular telephone via text message.

15. The method of claim 14, wherein the list of items of interest is a list of most recently released movies.

16. In a web-based system, a method of predicting the compatibility of a first user of the system to at least one other user of the system, comprising the steps of:
(a) providing a survey of items for rating by the first system user;
(b) collecting a set of ratings for the survey of items from the first system user;
(c) collecting a set of ratings for the survey of items from each of a plurality of raters;
(d) calculating a correlation coefficient between the first system user and each of the plurality of raters to obtain a set of correlation coefficients for the survey of items;
(e) predicting the compatibility of the first system user to at least one of the plurality of raters from the correlation coefficients calculated between the system user and each of the group of raters; and
(f) providing to the first system user at least one other user selected on the basis of correlation to the first system user from the plurality of raters.

17. The method of claim 16, wherein the survey of items is a list of movies.

18. The method of claim 17, wherein the plurality of raters are selected from a list of system users.

19. The method of claim 16, wherein said step of calculating a correlation coefficient between the system user and each of the plurality of raters to obtain a set of correlation coefficients for the survey of items comprises the steps of:
(i) obtaining a list of items from the survey of items that the system user and the plurality of raters have rated;
(ii) storing the list of items obtained in step (i) in a temporary list in the form of rating pairs;
(iii) calculating a mean user rating of survey items and a mean rater rating for each of the plurality of raters of survey items from the temporary list;
(iv) calculating the difference between each user rating from the survey of items and the mean user rating; and
(v) calculating the difference between each rater rating from the survey of items and the mean rater rating.

20. The method of claim 19, wherein said step of calculating a correlation coefficient between the system user and each of the plurality of raters to obtain a set of correlation coefficients for the survey of items further comprises the steps of:
(vii) multiplying the difference between each user rating and the mean user rating and the difference between each rater rating and the mean rater rating for each movie rate;
(viii) summing the multiplied differences from step (vii) to determine a coefficient of variance;
(ix) dividing the sum obtained in step (viii) by the number of items on the temporary list to arrive at a mean coefficient of variance;
(x) calculating a first standard deviation for the system user ratings on the temporary list and a second standard deviation of the rater ratings on the temporary list;
(xi) calculating the product of the first and second standard deviations; and
(xii) dividing the mean coefficient of variance obtained in step (ix) by the product of the first and second standard deviations obtained in step (xi) to determine a correlation coefficient between a system user and a rater.

21. A multi-user web-based computer system for predicting the compatibility of at least one item of interest to a user of the system, comprising:
(a) a web server for communicating with users of the web-based computer system and components thereof;
(b) a user profile database for storing information on system users;
(c) a user rating module for providing a survey of items for rating by the system user and collecting a set of ratings for storage within said user profile database;
(d) a computational process module, said computational process module having a correlation module for calculating a correlation coefficient between the system user and each of a plurality of raters to obtain a set of correlation coefficients for the survey of items and a predictive module for predicting the compatibility of the at least one item of interest to the system user from the ratings provided by the plurality of raters and the correlation coefficients calculated between the system user and each of the plurality of raters;
(e) a compatibility-based matched items table for receiving an output regarding the compatibility of the at least one item of interest to the system user from the computational process module; and
(f) a recommendation process module for receiving information from said compatibility-based matched items table and returning the information to said web server for transmitting to the system user.

22. The web-based computer system of claim 21, wherein the survey of items is a list of movies.

23. The web-based computer system of claim 22, wherein the plurality of raters are selected from a list of system users.

24. The web-based computer system of claim 22, wherein the plurality of raters are selected from a group of movie critics who have each rated the list of movies.

25. The web-based computer system of claim 24, further comprising a web crawler for obtaining the set of ratings for the survey of items.

26. The web-based computer system of claim 21, wherein said correlation module of said computational process module comprises:
(i) means for obtaining a list of items from the survey of items that the system user and the plurality of raters have rated;
(ii) means for storing the list of items in a temporary list in the form of rating pairs;
(iii) means for calculating a mean user rating of survey items and a mean rater rating for each of the plurality of raters of survey items from the temporary list;
(iv) means for calculating the difference between each user rating from the survey of items and the mean user rating; and
(v) means for calculating the difference between each rater rating from the survey of items and the mean rater rating.

27. The web-based computer system of claim 26, wherein said correlation module of said computational process module further comprises:
(vii) means for multiplying the difference between each user rating and the mean user rating and the difference between each rater rating and the mean rater rating for each movie rate;
(viii) means for summing the multiplied differences from step (vii) to determine a coefficient of variance;
(ix) means for dividing the sum obtained said summing means by the number of items on the temporary list to arrive at a mean coefficient of variance;
(x) means for calculating a first standard deviation for the system user ratings on the temporary list and a second standard deviation of the rater ratings on the temporary list;
(xi) means for calculating the product of the first and second standard deviations; and
(xii) means for dividing the mean coefficient of variance by the product of the first and second standard deviations to determine a correlation coefficient between a system user and a rater.

28. The web-based computer system of claim 27, wherein said predictive module of said computational process module comprises:
(i) means for selecting each system rater from the plurality of raters that has rated the item of interest;
(ii) means for selecting and storing the correlation coefficients between the system user and the system raters selected by said means for selecting each system rater determined by said correlation module of said computational process module;
(iii) means for raising each correlation coefficient to the power of k to obtain a weight;
(iv) means for calculating the sum of all weights;
(v) means for multiplying each weight by a corresponding rating and summing the product of each weight and corresponding rating to yield a raw score; and
(vi) means for dividing the raw score by the sum of all weights determined to obtain an estimate of prediction of compatibility of the at least one item of interest to the system user.

29. The web-based computer system of claim 28, wherein said predictive module of said computational process module further comprises:
(vii) means for calculating an average item rating for the system user;
(viii) means for calculating an average item rating for each system rater selected by said means for selecting each system rater;
(ix) means for calculating a correction factor by subtracting the average item rating for each system rater from the average item rating for the system user; and
(x) means for adding the correction factor to the estimate of rating prediction to obtain the prediction of compatibility of the at least one item of interest to the system user.

30. The web-based computer system of claim 21, wherein said predictive module of said computational process module comprises:
(i) means for selecting each system rater from the plurality of raters that has rated the item of interest;
(ii) means for selecting and storing the correlation coefficients between the system user and the system raters selected by said means for selecting each system rater determined by said correlation module of said computational process module;
(iii) means for raising each correlation coefficient to the power of k to obtain a weight;
(iv) means for calculating the sum of all weights;
(v) means for multiplying each weight by a corresponding rating and summing the product of each weight and corresponding rating to yield a raw score; and
(vi) means for dividing the raw score by the sum of all weights determined to obtain an estimate of prediction of compatibility of the at least one item of interest to the system user.

31. The web-based computer system of claim 30, wherein said predictive module of said computational process module further comprises:
(vii) means for calculating an average item rating for the system user;
(viii) means for calculating an average item rating for each system rater selected by said means for selecting each system rater;
(ix) means for calculating a correction factor by subtracting the average item rating for each system rater from the average item rating for the system user; and
(x) means for adding the correction factor to the estimate of rating prediction to obtain the prediction of compatibility of the at least one item of interest to the system user.

32. The web-based computer system of claim 21, further comprising:
(g) means for providing a list of items of interest to the system user and their corresponding predictions of compatibility over the mobile web to a web-enabled handheld device.

33. The web-based computer system of claim 32, wherein the list of items of interest is a list of most recently released movies.

34. The web-based computer system of claim 21, further comprising:
(g) means for providing a list of items of interest to the system user and their corresponding predictions of compatibility over the cellular telephone network to a cellular telephone via text message.

35. The web-based computer system of claim 34, wherein the list of items of interest is a list of most recently released movies.
